(19) United States
(12) Patent Application Publication
(10) Pub. No.: US 2013/0244028 A1
(43) Pub. Date: Sep. 19, 2013

(54) EXTRUDABLE URETHANE RELEASE COATING

(71) Applicants: Yu Yang, Eden Prairie, MN (US); David T. Yust, Woodbury, MN (US); Lei Wang, San Jose, CA (US); Jeffrey O. Emslander, Stillwater, MN (US); James P. DiZio, St. Paul, MN (US)

(72) Inventors: Yu Yang, Eden Prairie, MN (US); David T. Yust, Woodbury, MN (US); Lei Wang, San Jose, CA (US); Jeffrey O. Emslander, Stillwater, MN (US); James P. DiZio, St. Paul, MN (US)

(73) Assignee: 3M INNOVATIVE PROPERTIES COMPANY, St. Paul, MN (US)

(21) Appl. No.: 13/883,799

(22) PCT Filed: Nov. 28, 2011
(86) PCT No.: PCT/US2011/062174

§ 371 Date: May 7, 2013

Related U.S. Application Data
(60) Provisional application No. 61/419,363, filed on Dec. 3, 2010.

(51) Int. Cl. C08L 39/00; C09J 7/02

(52) U.S. Cl. CPC C08L 39/00; C09J 7/0228
USPC 428/352; 427/208.4; 525/217; 525/123; 525/175; 525/190

(57) ABSTRACT

Described herein is a release material comprising: a blend comprising: releasing agent comprising a urethane polymer derived from a polyvinyl polymer containing active hydroxyl groups and an aliphatic isocyanate; and a carrier polymer, wherein more than 50% by weight of the carrier polymer is non-olefinic, and articles thereof.

### TECHNICAL FIELD

A process for preparing a release material comprising a urethane polymer derived from a vinyl alcohol and an isocyanate; and a non-olefinic carrier polymer is described.

### BACKGROUND

Conventionally, release layer such as a release liner or a low adhesion backside (LAB, i.e., a back coat of an adhesive tape) were formed by coating and drying a releasing agent solution onto a susbtrate such as a film or paper. However, in recent years, there has been a trend towards solventless options, where the release layer, typically comprising a releasing agent blended with a polyolefin, is extruded.

Silicon compounds are especially effective as releasing agents when mixed with polyolefin resins. However, there is a possibility that the silicon compounds may transfer onto the adhesive surfaces of the adhesive sheets and when used, may give rise to harmful effects such as defective electrical contact and the like in electronic parts. Further, when used as a surface protection film prior to the painting of cars, it may become a cause of “crater/fisheye” in the painting process. Due to these reasons, a non-silicon-based releasing agent is desirable.

U.S. Pat. No. 7,193,028 (Kaifu et al.) describes preparing a non-silicon-based releasing agent wherein the releasing agent comprises a reaction product of an aliphatic isocyanate and an ethylene/vinyl alcohol copolymer. This releasing agent is then coated onto a substrate for use.

U.S. Pat. No. 6,146,756 (Ausen et al.) describes preparing a non-silicon-based, hot melt-processable release material comprising a backbone polymer having a grafting site that is reactive with a release component. In one embodiment, these release materials may be blended with olefin-containing polymers.

### SUMMARY

There is a desire to produce a release material that is extrudable and may provide advantages related to performance such as improved stability, and/or use such as recyclability.

In one aspect, a release material is provided comprising: a blend comprising: releasing agent comprising a urethane polymer derived from a polyvinyl polymer containing active hydroxyl groups and an aliphatic isocyanate; and a carrier polymer, wherein more than 50% by weight of the carrier polymer is non-olefinic.

In one embodiment, the carrier polymer is selected from at least one of a polyester, a polyurethane, a polyacrylate, a nylon, and a polyimide.

In another aspect, an article is provided comprising a release material comprising: (i) a blend comprising releasing agent comprising a urethane polymer derived from a polyvinyl polymer containing active hydroxyl groups and an aliphatic isocyanate; and a carrier polymer, wherein more than 50% by weight of the carrier polymer is non-olefinic and (ii) an adhesive in intimate contact with at least one major surface of the releasing sheet.

In yet another aspect, a method of making an adhesive article is provided comprising: blending a composition comprising a urethane polymer derived from a polyvinyl polymer containing active hydroxyl groups and an aliphatic isocyanate and a carrier polymer, wherein more than 50% by weight of the carrier polymer is non-olefinic; extruding or casting the blend to form a sheet; optionally heating the sheet; and applying an adhesive onto the sheet to form an adhesive article.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

FIG. 1 is a schematic representation of a side view of an adhesive article in a roll construction according to the present disclosure; and

FIG. 2 is an enlarged cross-sectional view of an adhesive article according to the present disclosure.

### DETAILED DESCRIPTION

As used herein, the term

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

As used herein, “release material” refers to a composition that is capable of being formed into a release coating.

“Release coating” refers to a component, preferably a film, that exhibits low adhesion to an adhesive, such as a pressure-sensitive-adhesive (PSA), so that separation can occur substantially between the adhesive and release coating interface. In tape applications, a release coating is often referred to as a “low adhesion backside,” or LAB. LABs typically have a release force value of less than about 50 N/dm and can be used in adhesive tape rolls, where the tape is wound upon itself and usage requires unwinding of the tape roll. Release coatings can also be used as a “liner” for other adhesive articles, such as labels or medical dressing bandages, where the adhesive article is generally supplied as a sheet-like construction, as opposed a roll-like construction. Release coatings used for liner applications typically possess a release force value of less than about 5 N/dm.

The present disclosure is directed to a release material comprising a blend of a releasing agent and a non-olefinic carrier polymer.

The releasing agent of the present disclosure is prepared by the reaction of an aliphatic isocyanate and a polyvinyl polymer containing active hydroxyl groups.

The aliphatic group of an aliphatic isocyanate used in the present disclosure is not particularly limited and may include an alkyl group, an alkenyl group, an alkynyl group, etc. The aliphatic group may be branched chain-like, but a linear chain-like aliphatic group is more preferable. The aliphatic group may comprise at least 8, 10, or even 12 carbons. Typically the aliphatic group comprises no more than 30, 25, or even no more than 20 carbon atoms.

Exemplary aliphatic isocyanates include: a monoalkyl isocyanate such as octyl isocyanate or dodecyl isocyanate (lauryl isocyanate) or octadecyl isocyanate (stearyl isocyanate), and combinations thereof.

The aliphatic isocyanates may be used alone or in a combination of two or more.

The polyvinyl polymer containing active hydroxyl groups may for example be an ethylene-vinyl alcohol copolymer.

The polyvinyl polymer containing active hydroxyl groups is not particularly limited, and in general has a weight average molecular weight between 10000 to 500000 grams/mole. The polyvinyl polymer used in the present disclosure has a polymerization degree of from 100 to 3,000, preferably from 150 to 2,000 and a saponification degree of from 50 to 100%, preferably from 60 to 100%. Commercially available examples of polyvinyl alcohol polymers include those available under the trade designations “GOHSENOL” manufactured by Nippon Synthetic Chemical Industry Co., Ltd. and “EVAL” manufactured by the Eval Compary of America.

In one embodiment, the reaction of the aliphatic isocyanate and the vinyl alcohol polymer is free of solvent.

The ratio of the aliphatic isocyanate to the vinyl alcohol polymer is not particularly limited, but the aliphatic isocyanate is generally from 0.5 to 1.5 equivalent, or 0.6 to 1.1 equivalent to the hydroxyl group of the vinyl alcohol polymer.

Reactions of aliphatic isocyanates with polyvinyl polymer are further described in Japanese Pat. No. 55-142096 (Kumagai et al.) and U.S. Pat. Nos. 5,990,238 (DiZio, et al.) and 6,146,756 (Ausen et al.).

In the present disclosure, the releasing agent is blended with a carrier polymer to form the release material. The carrier polymer of the present disclosure is a non-olefin based polymer. The carrier polymer may be an elastomer, a thermoplastic elastomer, or a plastic.

Exemplary non-olefin based polymers include: a polyester, a polyurethane, a polyacrylate, a polyamide (such as nylon), a polyimide, and combinations thereof. In one embodiment, the carrier polymer consists essentially of a polyester, a polyurethane, a polyacrylate, a polyamide, a polyimide, and combinations thereof. Consisting essentially of means that the carrier polymer is primarily composed of a polyester, a polyurethane, a polyacrylate, a polyamide, a polyimide, or combination thereof, however a small amount of other polymers may be present in amounts less than 10%, 5%, 1%, or even 0.1% or so long as the desired bulk properties of the polyester, a polyurethane, a polyacrylate, a polyamide, a polyimide, or combination thereof remain unchanged.

Non-olefin based polymers may be advantageous over olefin-based polymers because of their improved chemical resistance (e.g., to organic solvents), their ability to be recycled, their improved tenterability (i.e., ability to be stretched), and higher thermal stability (resulting from their higher glass transition temperature and higher melting point). For example, if the softening temperature of the carrier polymer is low (such as in the case of some olefin-based polymers), these polymers in a release coating contacting adhesive may demonstrate adhesion build when exposed to temperatures above ambient such as in heat-aging experiments, which use temperatures of 50 to 70° C. This may prevent such polymers from being used practically in a release coating in release liners or LABs.

In one embodiment, the carrier polymer comprises a low amount (in other words, less than 50%, 25%, 10%, 5%, or even 2%) of olefin-based polymer. In one embodiment, the carrier polymer is substantially free of an olefin-based polymer. Substantially free of an olefin-based polymer means that the carrier polymer comprises less than 1%, 0.5%, or even 0.1% of an olefinic polymer. Such examples of olefin-based polymers include: ethylene/vinyl copolymers, modified ethylene/vinyl acetate copolymers, and/or polyolefins (e.g., polyethylene or polypropylene).

In one embodiment, the carrier polymer comprises a low amount (in other words, less than 50%, 25%, 10%, 5%, or even 2%) of polyvinyl chloride polymer. In one embodiment, the carrier polymer is substantially free (in other words, less than %, 0.5%, or even 0.1%) of a polyvinyl chloride polymer.

Any suitable method can be used for preparing blends of the releasing agent and carrier polymer. Blending of the releasing agent and the carrier polymer may be done by any method that results in a substantially homogenous distribution of the polymers. For example, the releasing agent and the carrier polymer can be blended by melt blending, solvent blending, or any suitable physical means.

The release material according to the present disclosure may contain various additives, according to necessity, in addition to the releasing agent and the carrier polymer. The additives, such as a defoaming agent, a thickener, a surfactant, a lubricant, organic particles, inorganic particles, an antioxidant, an ultraviolet ray absorber, a dye, a pigment, another polymer compound, and a cross-linking agent, may be contained in ranges that do not impair the object of the present disclosure.

Preferably, to obtain release materials of the present disclosure, an extruder is used for their preparation, although any suitable reactor can be used. The release materials can be extruded in a wide variety of forms. For example, the release material may be formed in strands that can be subsequently formed into pellet shapes for subsequent hot-melt application to a substrate. Alternatively, the release material may be extruded in the form of a release coating. In this embodiment, the release material may, optionally, be co-extruded with one or more materials. For example, the release material can be co-extruded with a support layer (e.g., a backing material) and, if desired, a tie layer and/or an adhesive material.

The thickness of the extruded release material may be varied within a very wide range. For example, the coating thickness may vary from 0.1 (or less) micrometer (m) to as thick as desired. Preferably, the release layer is less than about 1 m thick. The thickness of the applied release coating can be significantly reduced by orienting the release coated film after the release material has been extruded onto the support layer.

In one embodiment, the release material may be stretched (or orientated) after extrusion, resulting in thin (e.g., less than 500, 200, 100, 50 or even 25 nm), uniform (i.e., less than 10%, 5%, 2%, 1% or even 0.5% variation cross-web) films. This may be advantageous to reduce cost, among other things.

The release material of the present disclosure can be generally used as a release coating on a solid support, which may be, for example, a sheet, a fiber, or a shaped object. One preferred type of support material is that which is used for adhesive-coated articles (e.g., pressure-sensitive-adhesive-coated articles), such as tapes, labels, bandages, and the like. The release material may be applied to at least a portion of at least one major surface (typically the entire surface) of suitable flexible or inflexible support material. Useful flexible support materials include paper, plastic films such as polypropylene, polyethylene, polyvinylchloride, polytetrafluoroethylene, polyester (e.g., polyethylene terephthalate), cellulose acetate, and the like.

Support materials can also be of woven fabric formed of threads of synthetic fibers or natural materials such as cotton or blends of these. Alternatively, support materials may be nonwoven fabric, such as air-laid webs of synthetic or natural fibers or blends of these. In addition, suitable support materials can be formed of metal, foils, or ceramic sheet material. Primers known in the art can be utilized to aid in the adhesion of the release coating to the support material.

When the release material is co-extruded with the support layer or is extrusion-coated onto a polymer support layer, it may be preferred for some applications that the support layer be orientable in at least one direction after extrusion of the release coating to form an oriented release-coated substrate. Such orientable films are known in the art. The term “oriented” as used herein refers to strengthening the polymer by stretching at a temperature below its crystalline melting point.

Hot-melt processable tie layers can be used to improve interlayer adhesion between co-extruded release materials and backings, for example. Examples of useful tie layers include: modified ethylene/vinyl acetate copolymers (e.g., available under the trade designation “BYNEL CXA 1123”, available from DuPont Chemical Co., Wilmington, Del.), maleated polypropylenes, ethylene/acrylic acid copolymers, and other materials.

When preparing adhesive-coated articles including the release material of the present disclosure, any suitable adhesive can be used. Adhesives useful in the preparation of articles containing the release material of the present disclosure include solvent-coated, water-based, hot-melt-processable, and radiation-activated adhesive systems. In one embodiment, the adhesive is a pressure-sensitive-adhesive. A pressure sensitive adhesive adheres with no more than applied finger pressure and can be permanently tacky. Pressure sensitive adhesives can be used with primers, tackifiers, plasticizers, and the like. The pressure sensitive adhesives are preferably sufficiently tacky in their normal dry state, and have a desired balance of adhesion, cohesion, stretchiness, elasticity and strength for their intended use. Those of ordinary skill in the art appreciate how to formulate a wide variety of pressure sensitive adhesives. Exemplary adhesives include: rubbers (such as natural rubbers, butyl rubbers, and silicone rubbers), nitriles, acrylates (including monomers such as acrylic acid and acrylamide), styrene block copolymers (such as styrene-butadiene-styrene, styrene-isoprene-styrene, styrene-butadiene random, styrene-ethylene/butylene-styrene, and styrene-ethylene/propylene), polyurethanes, polyisobutylenes, olefinic-based adhesives (such as olefin block copolymers), and combinations thereof.

Adhesives used in the present disclosure can be extrudable, such that they can be co-extruded with the release material and a backing material when forming tapes, for example. They may be crosslinked, if desired, after application. While it is preferred that the adhesive be applied by extrusion techniques, however, the adhesive may be applied by a variety of other techniques. It may be co-extruded with the release coating alone, or with a support layer and the release coating. Alternatively, it may be extruded onto a pre-existing surface.

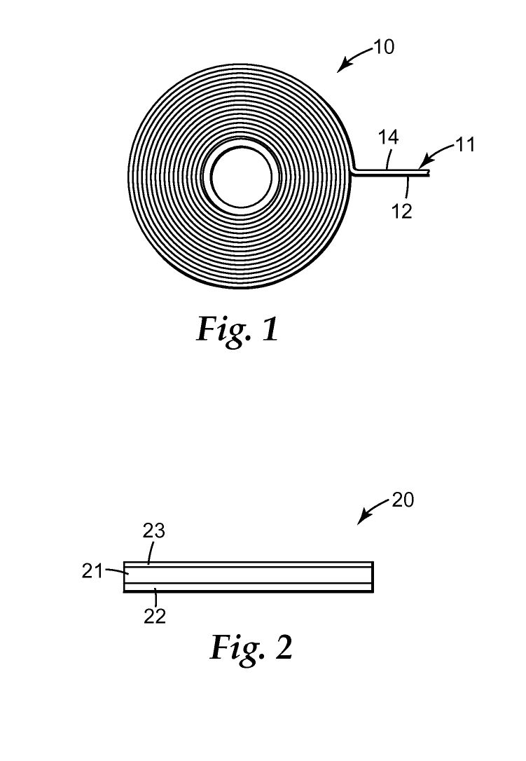

A release coating of the present disclosure can be used in a variety of formats such as low adhesion backside (LAB) for pressure-sensitive adhesive (PSA) tapes. For example, as shown in FIG. 1, a roll of tape 10 includes a flexible support layer 11, a pressure sensitive adhesive coating on one major surface 12 (i.e., a first major surface) of the support layer and a release coating on the opposite major surface 14 (i.e., a second major surface) of the support layer. The release coating is formed from the release material described above. The tape is wound into a roll such that the pressure sensitive adhesive releasably contacts the release coating. FIG. 2 is an exploded cross-section of a segment of the tape 10 (FIG. 1). Referring now to FIG. 2, the tape 20 includes the support layer 21, a pressure sensitive adhesive 22, and a release coating 23. The release coating 23 results in a lower specific adhesion toward the pressure sensitive adhesive than does the surface of the support material on which the pressure sensitive adhesive is coated. This permits unwinding of the tape from a roll without offsetting or transfer of the pressure sensitive adhesive from the support material. Another format is a transfer tape including a film of a pressure sensitive adhesive between two release liners, at least one being contacted with the release material described above. In another format, pressure sensitive adhesive is in intimate contact with both major surfaces of the release material.

In one embodiment, the adhesive article is substantially free of a primer layer between the adhesive and the release coating.

Particularly preferred articles including a release coating of the present disclosure are tapes, labels, wound dressings, and medical grade tapes.

### EXAMPLES

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available, for example from Sigma-Aldrich Chemical Company; Milwaukee, Wis., or known to those skilled in the art unless otherwise stated or apparent.

These abbreviations are used in the application and in the following examples: g=gram, kg=kilograms, min=minutes, mol=mole; cm=centimeter, mm=millimeter, mL=milliliter, MPa=mega Pascals, L=liter, N m=Newton meters, N/dm=Newton/decimeter, and wt=weight.

Test Method for Measuring Initial and Aged Release

The initial release test measured the effectiveness of release material prepared according to the disclosure immediately after the release material was laminated to a flexible adhesive tape. The aged release test measured the effectiveness of release material prepared according to the disclosure after they were laminated to a flexible adhesive tape and then aged at 49° C. for 7 days. The initial or aged release values are a quantitative measure of the force required to remove a flexible adhesive tape from the release material at a specific angle and rate of removal. This force is expressed in Newtons per decimeter (N/dm). Unless otherwise noted, the adhesive tape used to measure the initial and aged release value was a vinyl film with an acrylic adhesive commercially available from 3M Company, St. Paul, Minn. under trade designation “3M SCOTCHCAL 7725-13”.

To measure the initial and aged release values of release material according to the disclosure were laminated above-described adhesive tape with the release material facing the adhesive-bearing side of the tape. The resulting laminates were cut into test strips about 2.54 cm wide and approximately 12 cm long. The test strips were then either tested immediately without aging (for initial release) or aged for 7 days at a constant temperature of 49° C. The test strips were attached to the working platen of a slip/peel tester (Model SP2000, obtained from IMass, Inc., Accord, Mass.) using a 2.54 cm wide double-coated adhesive paper tape (commercially available from 3M Company, St. Paul, Minn. under the trade designation “3M DOUBLE COATED PAPER TAPE 410B”) applied to the release liner side of the test strip. The attached test strip was rolled once on the working platen with a 2 kg rubber roller. The adhesive tape of the test strip was then removed from the release liner by peeling at 180 degrees and a rate of 2.3 meters per minute (90 inches per minute), and the force required for removing the adhesive tape from the release liner was measured over a five-second data collection time.

All release tests were carried out in a facility at constant temperature (23° C.) and constant relative humidity (50 percent). At least three measurements were made for each example, and the data are reported as an average of all measurements. Measurements were made in pounds-force/inch and converted to N/dm.

### Materials

| Name | Description |
|---|---|
| Polyurethane | an aliphatic polyester-based thermoplastic polyurethane commercially |
| | available from Bayer Material Science, Pittsburgh, PA, under trade |
| | designation “TEXIN 3044” |
| Copolyester-A | a copolyester nominally having 72 mol % terephthalate moieties, 27 |
| | mol % trans-dimethyl 1,4-cyclohexandicarboxylate moieties, and 1 mol % |
| | cis-dimethyl 1,4 cyclohexandicarboxylate moieties, on an acids basis, |
| | and 4 mol % ethylene glycol moieties, 66 mol % 1,4- |
| | cyclohexanedimethanol moieties, 28 mol % 2,2-dimethyl-1,3- |
| | propanediol moieties, and 2 mol % triemthylolpropane moieties on a |
| | diols basis prepared in-house. |
| Copolyester-B | a copolyester nominally having 65 mol % terephthalate moieties and 35 |
| | mol % 4,4′-bibenzoate moieties, on an acids basis, and 100 mol % |
| | ethylene glycol moieties on a diols basis prepared in-house. |
| Copolyester ether | a copolyester ether commercially available from Eastman Chemical |
| | Company, Kingsport, TN under trade designation “NEOSTAR |
| | ELASTOMER FN007” |
| TPE-1 | a thermoplastic elastomer (TPE) commercially available from Kuraray |
| | Co., Ltd Tokyo, Japan under trade designation “KURARAY LA2250” |
| TPE-2 | a thermoplastic elastomer (TPE) commercially available from Kuraray |
| | Co., Ltd Tokyo, Japan under trade designation “KURARAY LA4285” |
| EVA-1 | Ethylene vinyl alcohol, M = 66 g/mol, 2 mol, 132 g, obtained from Eval |
| | Company of America, Houston, TX under trade designation “EVAL |
| | E105B” |
| | 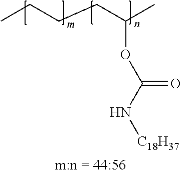 |
| EVA-2 | Ethylene vinyl alcohol, M = 54.36 g/mol, 1.46 mol, 79.36 g obtained |
| | from Eval Company of America, Houston, TX under trade designation |
| | “EVAL E104B” |
| | 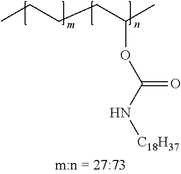 |

Preparative Sample 1

Preparative Sample 1 describes the process for the preparation of following compound which is referred to herein as “Additive 1”.

EVA-1 and 1250 mL xylene were charged into a 5 L flask with mechanical stirring. The mixture was heated for 1 hour to reflux to azeotropically remove the water. Then 650 g ODI (2.2 mol octadecyl isocyanate, molecular weight=295.51 g/mol) and 0.5 g dibutyltin diacetate were added. The mixture was heated and refluxed for 10-14 hours. The hot solution was precipitated into isopropyl alcohol (IPA). The precipitate was dried in an oven at 120° C. The dried solid was dissolved in toluene and precipitated again using IPA. The precipitate was then dried in oven and 475 g of the Additive 1 polymer was obtained. The decomposition temperature of the Additive 1 polymer was above 220° C. as determined via thermo-gravimetric analysis (TGA).

Preparative Sample 2

Preparative Sample 2 describes the process for the preparation of following compound which is referred to herein as “Additive 2”

EVA-2 and 1250 mL xylene was charged into a 5 L flask with mechanical stirring. The mixture was heated for 1 hour to reflux to azeotropically remove the water. Then, 650 g ODI (2.2 mol) and 0.5 g dibutyltin diacetate were added. The mixture was heated and refluxed for 10-14 hours. The hot solution was precipitated into isopropyl alcohol (IPA). The precipitate was dried in an oven at 120° C. The dried solid was dissolved in toluene and precipitated again from IPA. The precipitate was then dried in oven and 485 g of the Additive 2 polymer was obtained. The decomposition temperature of the Additive 2 polymer was above 220° C. as determined via TGA.

### Examples 1-12 and Comparative Examples A-F

Examples 1-12 were prepared by blending carrier polymers and Additive 1 at predetermined ratios and extruding them into films. Comparative examples A-F were prepared by extruding carrier polymers without any additive. The extrusion of examples 1-12 and comparative examples A-F were accomplished by using a twin-screw extruder, made by C.W. Brabender Instruments, South Hackensack, N.J. The extruder was equipped with a feed tube, three-temperature zone barrel, a screen pack, a die adaptor and a die. The temperatures of each zones of the barrel as well as the die and die adaptor were controlled. The temperature of barrel zones 1, 2 and 3 were 182° C., 193° C. and 193° C., respectively, for examples 1-10 and comparative examples A-E, and 204° C., 221° C. and 221° C., respectively, for examples 11-12 and comparative example F. The temperature of the die and die adaptor were 193° C., and screen pack was 40-80-40 for all of examples 1-12 and comparative examples A-F. The screw speed was 90 rpm for all examples and comparative examples except for example 6, where the screw speed was 120 rpm. The temperature of the feed tube was 204° C. for examples 11-12 and comparative example F. The nature and relative amount of carrier polymer, additives and the extrusion parameters measured during extrusion are listed below in Table 1.

TABLE 1

| | | Weight ratio of | Torque | Barrel |
|---|---|---|---|---|
| | | carrier | generated | Pressure |
| Example | Carrier Polymer | polymer:additive 1 | (N m) | (MPa) |
| CE- A | Polyurethane | 100:0 | 41.90 | 18.73 |
| 1 | | 95:5 | 18.71 | 9.14 |
| 2 | | 90:10 | 11.66 | 4.44 |
| CE- B | Copolyester-A | 100:0 | 61.97 | 11.057 |
| 3 | | 95:5 | 22.92 | 7.26 |
| 4 | | 90:10 | 10.03 | 3.82 |
| CE- C | Copolyester ether | 100:0 | 18.03 | 9.28 |
| 5 | | 95:5 | 12.75 | 6.04 |
| 6 | | 90:10 | 8.41 | 3.51 |
| CE- D | TPE-1 | 100:0 | 29.15 | 3.10 |
| 7 | | 95:5 | 11.26 | 2.66 |
| 8 | | 90:10 | 15.46 | 2.21 |
| CE- E | TPE-2 | 100:0 | 42.58 | 8.95 |
| 9 | | 95:5 | 14.10 | 5.26 |
| 10 | | 90:10 | 11.12 | 3.08 |
| CE- F | Copolyester-B | 100:0 | 51.53 | 9.03 |
| 11 | | 95:5 | 13.29 | 3.62 |
| 12 | | 90:10 | 8.68 | 2.22 |

Initial and aged release values obtained as described above for the release material of Examples 1-12 and comparative examples A-F are shown in Table 2 below. As shown in table 2, each sample was tested 3 times and the average release force was reported. Samples tore during the testing were not counted in the average reported result. Unless otherwise noted, the testing was done on the glossy side of the film.

TABLE 2

| | Initial Release Test (N/dm) | | | | Aged Release Test (N/dm) | | | |
|---|---|---|---|---|---|---|---|---|
| Example | Trial 1 | Trial 2 | Trial 3 | Average | Trial 1 | Trial 2 | Trial 3 | Average |
| CE- A | Torn | Torn | Torn | — | Torn | Torn | Torn | — |
| 1 | Torn | Torn | Torn | — | ~3.5-4 | ~3.5-4 | ~3.5-4 | — |
| 2 | Torn | Torn | Torn | — | Torn | Torn | Torn | — |
| CE- B | Torn | Torn | Torn | — | Torn | 3.66 | 4.38 | 4.02 |
| 3 | 12.96 | Torn | Torn | 12.96 | Torn | Torn | Torn | — |
| 4 | 11.91 | Torn | Torn | 11.91 | Torn | Torn | 1.89 | 1.89 |
| CE- C | Torn | Torn | Torn | — | Torn | 2.26 | 2.23 | 2.25 |
| 5 | 6.48 | 19.61 | 5.6 | 1.51 | 0.98 | 1.80 | 0.38 | 1.05 |
| 6 | Torn | Torn | Torn | — | Tore | 2.00 | 2.15 | 2.08 |
| CE- D* | 10.86 | 11.91 | 10.33 | 11.03 | 0.62 | 0.65 | 0.67 | 0.65 |
| 7* | 6.65 | 2.28 | 1.93 | 3.68 | 0.55 | 0.52 | 0.47 | 0.51 |
| 8* | 5.95 | 6.13 | 5.95 | 5.95 | 0.59 | 0.57 | 0.52 | 0.56 |
| CE- E | 4.03 | 4.38 | 4.03 | 4.21 | 0.25 | 0.23 | 0.23 | 0.24 |
| 9 | 2.28 | 2.45 | 2.28 | 2.28 | 0.13 | 0.12 | 0.16 | 0.14 |
| 10 | 1.58 | 1.58 | 1.93 | 1.75 | 0.11 | 0.13 | 0.17 | 0.14 |
| CE- F | Torn | Torn | Torn | — | 4.33 | 4.16 | 4.02 | 4.17 |
| 11 | Torn | Torn | Torn | — | 1.47 | 1.59 | 1.83 | 1.63 |
| 12 | Torn | Torn | Torn | — | 1.04 | 1.16 | 1.27 | 1.16 |

*Testing performed on the matte side of the film

Foreseeable modifications and alterations of this invention will be apparent to those skilled in the art without departing from the scope and spirit of this invention. This invention should not be restricted to the embodiments that are set forth in this application for illustrative purposes.

1. A release material comprising:
a blend comprising:
releasing agent comprising a urethane polymer derived from a polyvinyl polymer containing active hydroxyl groups and an aliphatic isocyanate; and
a carrier polymer, wherein more than 50% by weight of the carrier polymer is non-olefinic.

2. The release material of claim 1, wherein the carrier polymer is selected from at least one of a polyester, a polyurethane, a polyacrylate, a polyamide, and a polyimide.

3. The release material of claim 1, wherein the blend comprises less than 1% of a polyolefin based polymer.

4. The release material of claim 1, wherein the polyvinyl polymer containing active hydroxyl groups is an ethylene-vinyl alcohol copolymer.

5. The release material of claim 1, wherein the isocyanate is selected from at least one of lauryl isocyanate and octadecyl isocyanate.

6. An article comprising:
a release coating comprising a blend comprising: (i) a releasing agent comprising a urethane polymer derived from a polyvinyl polymer containing active hydroxyl groups and an aliphatic isocyanate; and (ii) a carrier polymer, wherein more than 50% by weight of the carrier polymer is non-olefinic;
and an adhesive in intimate contact with at least one major surface of the release coating.

7. The article of claim 6, wherein the adhesive is a pressure sensitive adhesive.

8. The article of claim 7, wherein the pressure sensitive adhesive is selected from at least one of an acrylate, a rubber, and a stryrene block copolymer.

9. The article of claim 6, wherein the adhesive is in intimate contact with both major surfaces of the release coating.

10. The article of claim 6, wherein the article is substantially free of a primer layer between the adhesive and the release coating.

11. The article of claim 6, further comprising a support layer in intimate contact with the release coating.

12. The article of claim 11, wherein the support layer is selected from at least one of a paper, a fabric, and a plastic film.

13. A method of making an adhesive article comprising:
blending a composition comprising (i) a urethane polymer derived from a polyvinyl polymer containing active hydroxyl groups and an aliphatic isocyanate and (ii) a carrier polymer, wherein more than 50% by weight of the carrier polymer is non-olefinic;
extruding or casting the blend to form a sheet;
optionally heating the sheet; and
applying an adhesive onto the sheet to form an adhesive article.

14. The method of claim 13, further comprising stretching the blend after extrusion.
